(19) United States
(12) Patent Application Publication
(10) Pub. No.: US 2025/0279708 A1
(43) Pub. Date: Sep. 4, 2025

(54) HYBRID DRIVE RESOLVER ROTOR MOUNTING ARRANGEMENT

(71) Applicant: Schaeffler Technologies AG & Co. KG, Herzogenaurach (DE)

(72) Inventors: Eric Ubelhart, Orville, OH (US); Peter Rentfrow, Doylestown, OH (US)

(73) Assignee: Schaeffler Technologies AG & Co. KG, Herzogenaurach (DE)

(21) Appl. No.: 18/594,085

(22) Filed: Mar. 4, 2024

(51) Int. Cl. H02K 24/00; B60K 6/40

(52) U.S. Cl. CPC H02K 24/00; B60K 6/40

(57) ABSTRACT

A hybrid drive arrangement for an internal combustion engine is provided, and includes an emotor having a rotor that is connected to the crankshaft and a stator that is fixed relative to the engine. A flex plate is connected for rotation with the rotor, and a resolver drive shaft extends from the flex plate, coaxial with the rotor. A resolver is provided having a resolver rotor that is connected with the resolver drive shaft at a position spaced apart from the flex plate, and a resolver stator is fixed relative to the emotor stator and located in proximity to the resolver rotor. A resolver rotor support acts to support the resolver drive shaft in proximity to the resolver stator. This arrangement isolates deflections caused by the crankshaft so that the radial deflections of the resolver rotor are minimized in order to ensure proper functioning of the resolver.

### FIELD OF INVENTION

The disclosure relates to a hybrid drive architecture for hybrid electric vehicles. More specifically, it relates to P0 and P1 hybrid drive architectures and mounting of sensors used for detecting rotational position and speed of cantilever mounted electric motor rotors.

### BACKGROUND

In a P1 hybrid architecture, an electric motor (emotor) is integrated into the drivetrain with the rotor directly engaged with the crankshaft of the internal combustion engine (ICE), and torque from the emotor and/or the ICE is transmitted via a transmission assembly that includes the torque converter to the transmission gear box. In a P0 hybrid architecture, the emotor is connected to the front of the ICE

In certain P0 and P1 hybrid architectures, the emotor rotor has radial/angular movement due to the emotor rotor being mounted to the engine crankshaft in a cantilever arrangement, for example due to vibration and piston-firing induced crankshaft flexing due to the direct mounting of the emotor rotor to the crankshaft. For monitoring and control of the emotor, a resolver is mounted to the rotor in order to determine an angular velocity and position of the emotor rotor. However, if the resolver rotor is mounted too far from the base mounting surface of the rotor, it can see high radial displacement. This can cause issues with the Transformation ratio (input voltage to output voltage) due to the changing air gap between the resolver rotor and its own pick-up/stator. This can lead to signal processing issues and speed read out issues in the inverter controlling the emotor.

It would be desirable to find a cost-effective solution to these issues that improves quality and performance.

### SUMMARY

In one aspect, a hybrid drive arrangement for an internal combustion engine having a crankshaft is provided. The hybrid drive arrangement includes an emotor having a rotor that is connected to the crankshaft and a stator that is fixed relative to the engine. A flex plate is connected for rotation with the rotor, and a resolver drive shaft extends from the flex plate, coaxial with the rotor. A resolver is provided having a resolver rotor that is connected with the resolver drive shaft at a position spaced apart from the flex plate, and a resolver stator is fixed relative to the emotor stator and located in proximity to the resolver rotor. A resolver rotor support acts to support the resolver drive shaft in proximity to the resolver stator. With this arrangement, a resolver rotor that is spaced apart from the crankshaft/emotor rotor connection rotates in a more stable manner, isolated from the deflections caused by the crankshaft so that the radial deflections of the resolver rotor are minimized in order to ensure proper functioning of the resolver and accurate readouts for the control functions of the emotor inverter.

In one embodiment, the flex plate includes a multi-plate stack.

In one embodiment, the resolver rotor support comprises a bearing or a bushing.

In one embodiment, an accessory element is drivingly connected to the resolver drive shaft. The accessory element can be a pump, and the resolver drive shaft extends through a pump housing of the pump. The pump can be used to deliver cooling fluid to the emotor stator. Alternatively, other types of accessory drive elements can be attached to the resolver drive shaft.

In one embodiment, the resolver rotor is located on an opposite side of the pump housing from the flex plate. In order to provide a space saving arrangement, the pump housing can be located at least partially within the rotor.

In one embodiment, a fixed support extends from a region of the stator, and the resolver stator is mounted to the fixed support. The resolver rotor support can be mounted on the fixed support.

In another aspect, an emotor assembly for a hybrid drive arrangement is provided. The emotor assembly includes a rotor that is adapted to be connected to a crankshaft and a stator that is fixed to an emotor housing. A flex plate is connected for rotation with the rotor, and a resolver drive shaft extends from the flex plate coaxial with the rotor. A resolver rotor is connected with the resolver drive shaft at a position spaced apart from the flex plate, and a resolver stator is fixed relative to the emotor housing and located in proximity to the resolver rotor. A resolver rotor support acts to support the resolver drive shaft in proximity to the resolver stator. The components of the emotor assembly can be preassembled as a unit during manufacture, and the thus pre-assembled emotor assembly can be installed as a single assembly onto an ICE of a hybrid vehicle drive system.

In one embodiment, the flex plate includes a multi-plate stack.

In one embodiment. The resolver rotor support comprises a bearing or a bushing.

In one embodiment, an accessory element is drivingly connected to the resolver drive shaft. The accessory element can be a pump, and the resolver drive shaft extends through a pump housing of the pump. The resolver rotor can be located on an opposite side of the pump housing from the flex plate, and the pump housing can located at least partially within the rotor.

In one embodiment, a fixed support extends from the emotor housing in a region of the stator, and the resolver stator is mounted to the fixed support. The resolver rotor support can also be mounted on the fixed support.

Various features of the invention can be used alone or in combination in order to achieve one or more of the benefits described herein.

### BRIEF DESCRIPTION OF THE DRAWINGS

The foregoing Summary and the following detailed description will be better understood when read in conjunction with the appended drawings, which illustrate preferred embodiments according to the disclosure. In the drawings:

FIG. 1 is a cross-sectional view of a hybrid drive arrangement for an internal combustion engine in accordance with a first embodiment of the disclosure.

FIG. 2 is a cross-sectional view of a hybrid drive arrangement for an internal combustion engine in accordance with a second embodiment of the disclosure.

FIG. 3 is a cross-sectional view of a hybrid drive arrangement for an internal combustion engine in which the resolver drive shaft also drives an accessory element.

### DETAILED DESCRIPTION

Certain terminology is used in the following description for convenience only and is not limiting. The words “inwardly” and “outwardly” refer to directions toward and away from the parts referenced in the drawings. “Axially” refers to a direction along the axis of a shaft. “Radially” refers to a direction normal to an axis. A reference to a list of items that are cited as, for example, “at least one of a or b” (where a and b represent the items being listed) means any single one of the items a or b, or a combination of a and b thereof. This would also apply to lists of three or more items in like manner so that individual ones of the items or combinations thereof are included. The terms “about” and “approximately” encompass + or −10% of an indicated value unless otherwise noted. The terminology includes the words specifically noted above, derivatives thereof and words of similar import.

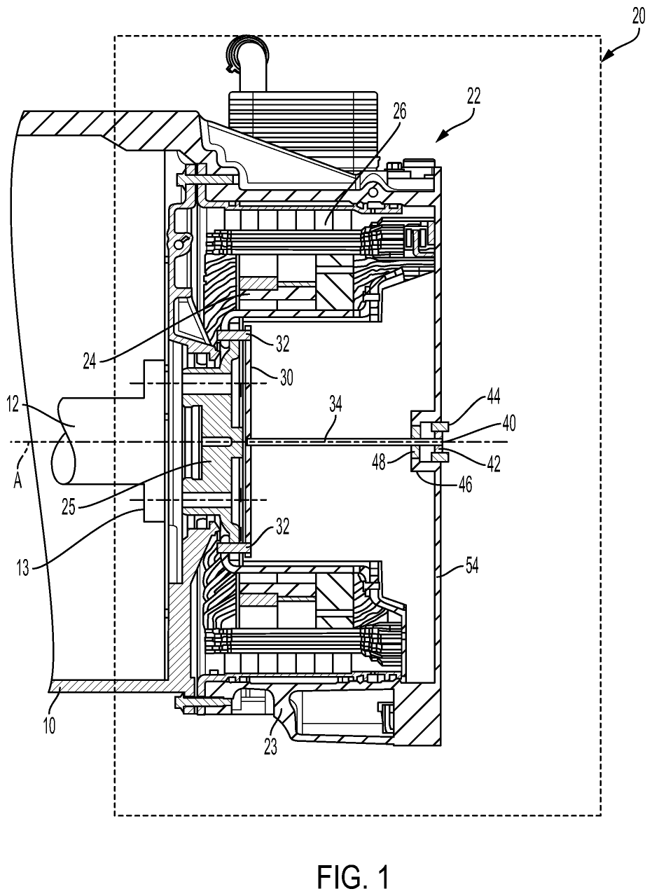

Referring to FIG. 1, a hybrid drive arrangement 20 for an internal combustion engine, indicated at 10 and includes a crankshaft 12, is shown. The hybrid drive arrangement 20 includes an emotor assembly 22 (referred to as emotor 22) having a housing 23 in which a rotor 24 is located that is connected to the crankshaft 12. This connection can be via connection to a bolt flange 13 on the crankshaft 12 as shown or via other suitable means. The housing 23 can be made of one or more housing parts that area connected together. A stator 26 is fixed relative to the engine 10 (once the emotor housing 23 within which it is mounted is connected to the engine 10), with the rotor 24 being mounted for rotation within the stator 26.

A flex plate 30 is connected for rotation with the rotor 24. As shown, the flex plate 30 can be connected to the rotor 24 via fasteners 32, such as bolts or rivets that extend through the flex plate 30 as well as a rotor hub 25. The flex plate 30 can be formed from spring steel, and can be a stamped part.

As shown in FIG. 1, a resolver drive shaft 34 extends from the flex plate 30 coaxial with the rotor 24. A resolver 40 is provided in order to track a position and angular velocity of the rotor 24 and signals speed and position information to an inverter that controls the emotor 22. The resolver 40 includes a resolver rotor 42 that is connected with the resolver drive shaft 34 at a position spaced apart from the flex plate 30. A resolver stator 44, which is used to pick up position signals from the resolver rotor 42, is fixed relative to the emotor stator 26 and located in proximity to the resolver rotor 42. The resolver stator 44 can be mounted, for example, on a fixed support 54 that extends from a region of the stator 26. This fixed support 54 can be part of the emotor housing 23 or fastened to the emotor housing 23. A resolver rotor support 46 supports the resolver drive shaft 34 in proximity to the resolver stator 44. In the illustrated embodiment, the resolver rotor support 46 is mounted on the fixed support 54. However, it could be supported in another manner that is fixed relative to the engine 10 and/or the stator 26.

The resolver rotor support 46 may include a bearing or bushing 48 in order to reduce friction as the resolver drive shaft 34 rotates with the rotor 24 of the emotor 22.

With this arrangement, during use any deflections generated from the crankshaft mounting of the emotor rotor 24 are isolated from the resolver rotor 42 due to the flex plate 30 and the resolver rotor support 46. This allows an air gap, typically in the 1-2 mm range, between the resolver rotor 42 and the resolver stator 44 to remain generally constant, improving the accuracy of the resolver and thee signals sent to the inverter for the motor 22.

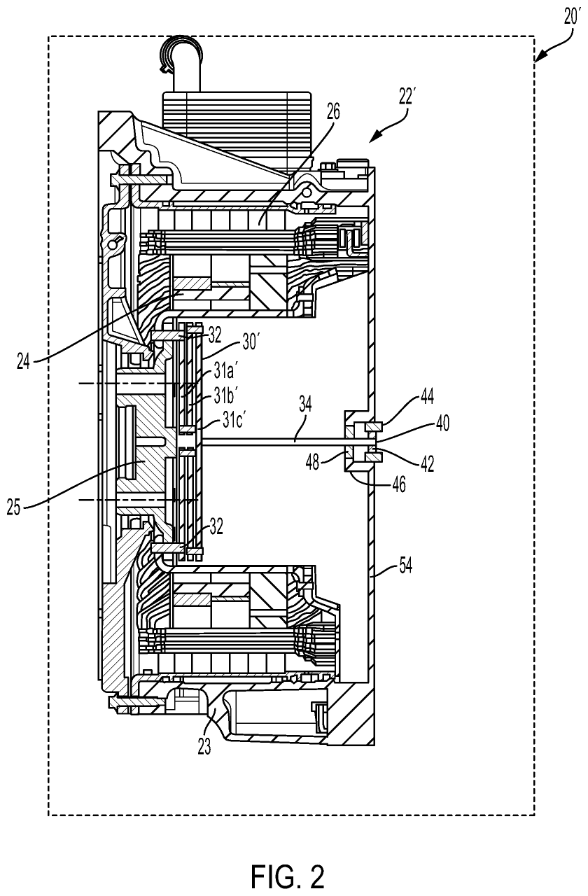

Referring now to FIG. 2, a second embodiment of the hybrid drive arrangement 20′ is shown. The second embodiment of the hybrid drive arrangement 20′ is the same as the first embodiment of the hybrid drive arrangement 20 and like elements have been indicated with the same element numbers and the same description and function noted above also applies. The differences in the emotor 22′ are described below.

As shown in FIG. 2, the flex plate 30′ is formed as a multi-plate stack including plates 31a′, 31b′, 31c′ that are fastened together in order to provide more flex in the flex plate 30′ than the single plate flex plate 30 in the first embodiment. This has the same function of allowing the resolver rotor 42 to rotate with a generally constant air gap between the resolver rotor 42 and the resolver stator 44. This ensures accurate pickup of position and angular velocity of the resolver rotor 42 by the resolver stator 44 as the rotor 24 of the emotor 22′ is rotated. Isolating vibrations from the crankshaft 12 and/or other sources from the engine 10 enables more consistent functioning of the resolver 40 in determining the position of the rotor 24 and the angular velocity without inaccuracies and/or defaults based on varying air gaps in arrangements where the resolver rotor is mounted directly with the emotor rotor, particularly for cantilevered mounting arrangements as shown that are typical of P0 and P1 hybrid drive arrangements.

In the illustrated embodiment, three flex plates 31a′, 31b′, 31c′ are shown. Inner ends of the first flex plate 31a′ are attached to inner ends of the second flex plate 31b′, and outer ends of the second flex plate 31b′ are connected to outer ends of the third flex plate 31c′ to which the resolver drive shaft 34 is mounted. Here, outer ends of the first flex plate 31a′ are connected to the rotor 24 of the emotor 22′. As will be recognized by those skilled in the art, the number of flex plates as well as their spring form/spring factor can be adjusted depending upon the particular application.

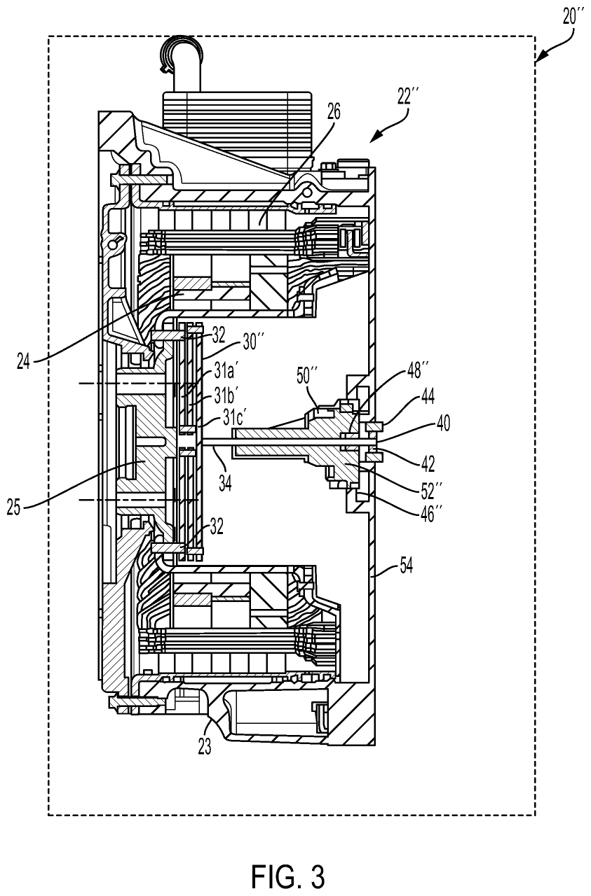

Referring now to FIG. 3, a third embodiment of a hybrid drive arrangement 20″ is shown. The third embodiment of the hybrid drive arrangement 20″ is substantially the same as the second embodiment of the hybrid drive arrangement 20′ and like elements are indicated with the same reference numerals and the same description and function noted above also applies. The differences in the emotor 22″ are described below.

As shown in FIG. 3, an accessory element 50″ is drivingly connected to the resolver drive shaft 34 and is driven thereby. The accessory element 50″ may be an oil pump that is used to spay cooling oil on the stator 26. However, it could also be a different accessory drive element.

In the illustrated embodiment, the resolver drive shaft 34 extends through a pump housing 52″ of the accessory element 50″ which is a pump. Here, the resolver rotor 42 is located on an opposite side of the pump housing 52″ from the flex plate 30′. In order to save space, the pump housing 52″ can be located at least partially within the rotor 24. In the illustrated embodiment, the resolver rotor support 46″ is in the form of a bushing or bearing 48″ that is located within the housing 52″ of the pump 50″.

For each of the embodiments of the hybrid drive arrangement 20, 20′, 20″, the emotor assembly 22, 22′, 22″ can be pre-assembled as a unit that is then connected to the internal combustion engine 10. This saves assembly time during final assembly of the internal combustion engine 10. Here, the emotor assembly 22, 22′, 22″ includes the rotor 24 which is adapted to be connected to the crankshaft 12 as well as the stator 26 that is affixed to the emotor housing 23. The flex plate 30, 30′ (shown in FIGS. 1 and 2) is connected for rotation with the rotor 24 and the resolver drive shaft 34 extends from the flex plate 30, 30′ co-axial with the rotor 24. The resolver 40 is assembled in the emotor assembly 22, 22′, 22″ with the resolver rotor 42 connected to the resolver drive shaft 30 at a position spaced part form the flex plate 30, 30′. The resolver stator 44 is fixed relative to the emotor housing 23, for example with the fixed support 54 that can be a part of or attached to the emotor housing 23. The resolver rotor support 46, 46″ supports the resolver drive shaft 34 in proximity to the resolver stator 44 in order to avoid radial shifting of the resolver rotor 42 which can cause an inconsistent air gap between the resolver rotor 42 and the resolver stator 44 that can cause issues in connection with the transformation ratio leading to signal processing issues and speed read out issues as discussed above in the inverter controlling the emotor 22, 22′, 22″. To the extend provided, the pump 50″ can also be preassembled in the emotor assembly 22″

Having thus described the presently preferred embodiments in detail, it is to be appreciated and will be apparent to those skilled in the art that many physical changes, only a few of which are exemplified in the detailed description, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope that is indicated by the appended claims rather than by the foregoing description, and all alternate embodiments and changes to this embodiment which come within the meaning and range of equivalency of said claims are therefore to be embraced therein.

### LIST OF REFERENCE SYMBOLS

10 internal combustion engine
12 crankshaft
20, 20′, 20″ hybrid drive arrangement
22, 22′, 22″ emotor
23 emotor housing
24 rotor
25 rotor hub
26 stator
30, 30′ flex plate
31a′, 31b′, 31c′ plates
32 fasteners
34 resolver drove shaft
40 resolver
42 resolver rotor
44 resolver stator
46, 46″ resolver rotor support
48, 48″ bearing or bushing
50″ accessory element/pump
52″ pump housing
54 fixed support

1. A hybrid drive arrangement for an internal combustion engine having a crankshaft, the hybrid drive arrangement comprising:
an emotor having a rotor that is connected to the crankshaft and a stator that is fixed relative to the engine;
a flex plate connected for rotation with the rotor;
a resolver drive shaft extending from the flex plate coaxial with the rotor;
a resolver rotor connected with the resolver drive shaft at a position spaced apart from the flex plate;
a resolver stator fixed relative to the emotor stator and located in proximity to the resolver rotor; and
a resolver rotor support that supports the resolver drive shaft in proximity to the resolver stator.

2. The hybrid drive arrangement of claim 1, wherein the flex plate includes a multi-plate stack.

3. The hybrid drive arrangement of claim 1, wherein the resolver rotor support comprises a bearing or a bushing.

4. The hybrid drive arrangement of claim 1, further comprising an accessory element drivingly connected to the resolver drive shaft.

5. The hybrid drive arrangement of claim 4, wherein the accessory element is a pump, and the resolver drive shaft extends through a pump housing of the pump.

6. The hybrid drive arrangement of claim 5, wherein the resolver rotor is located on an opposite side of the pump housing from the flex plate.

7. The hybrid drive arrangement of claim 5, wherein the pump housing is located at least partially within the rotor.

8. The hybrid drive arrangement of claim 1, further comprising a fixed support extending from a region of the stator, and the resolver stator is mounted to the fixed support.

9. The hybrid drive arrangement of claim 1, wherein the resolver rotor support is mounted on the fixed support.

10. An emotor assembly for a hybrid drive arrangement, the emotor assembly comprising:
a rotor that is adapted to be connected to a crankshaft;
a stator that is fixed to an emotor housing;
a flex plate connected for rotation with the rotor;
a resolver drive shaft extending from the flex plate coaxial with the rotor;
a resolver rotor connected with the resolver drive shaft at a position spaced apart from the flex plate;
a resolver stator fixed relative to the emotor housing and located in proximity to the resolver rotor; and
a resolver rotor support that supports the resolver drive shaft in proximity to the resolver stator.

11. The emotor assembly of claim 10, wherein the flex plate includes a multi-plate stack.

12. The emotor assembly of claim 10, wherein the resolver rotor support comprises a bearing or a bushing.

13. The emotor assembly of claim 10, further comprising an accessory element drivingly connected to the resolver drive shaft.

14. The emotor assembly of claim 13, wherein the accessory element is a pump, and the resolver drive shaft extends through a pump housing of the pump.

15. The emotor assembly of claim 14, wherein the resolver rotor is located on an opposite side of the pump housing from the flex plate.

16. The emotor assembly of claim 14, wherein the pump housing is located at least partially within the rotor.

17. The emotor assembly of claim 10, further comprising a fixed support extending from a region of the stator, and the resolver stator is mounted to the fixed support.

18. The emotor assembly of claim 10, wherein the resolver rotor support is mounted on the fixed support.
